(19) United States
(12) Patent Application Publication
(10) Pub. No.: US 2015/0369770 A1
(43) Pub. Date: Dec. 24, 2015

(54) BIOSENSOR AND METHOD FOR MANUFACTURING SAME

(71) Applicant: TANAKA KIKINZOKU KOGYO K.K., Chiyoda-ku, Tokyo (JP)

(72) Inventors: Yuka INOSE, Tokyo (JP); Junko SHIMAZAKI, Tokyo (JP); Masaaki KURITA, Kanagawa (JP); Takashi NISHIMORI, Kanagawa (JP)

(21) Appl. No.: 14/761,260

(22) PCT Filed: Jan. 16, 2014
(86) PCT No.: PCT/JP2014/050723

§ 371 Date: Jul. 15, 2015

(30) Foreign Application Priority Data
Jan. 17, 2013 (JP) 2013-006560

(51) Int. Cl. G01N 27/327

(52) U.S. Cl. CPC G01N 27/3272

(57) ABSTRACT

The present invention provides a biosensor capable of measuring various blood components, in particular, the concentration of blood glucose with high accuracy even when a hematocrit level varies. The above-described object was achieved by a biosensor 10, which includes an electrically insulating substrate 102, an electrode system 104 including a working electrode 1042 and a counter electrode 1044 formed on the electrically insulating substrate 102, and a reagent layer 204 containing an oxidoreductase and a redox mediator, and in which the electrode system 104 is formed from gold, a hydrophilic polymer layer 202 is provided on the electrode system 104, and the reagent layer 204 is provided outside the hydrophilic polymer layer 202 so that the oxidoreductase and the redox mediator are transferred to the hydrophilic polymer layer 202 after coming into contact with a sample.

### TECHNICAL FIELD

The present invention relates to a biosensor and a method for producing the same, and particularly relates to a biosensor capable of measuring a blood component such as glucose with high accuracy.

### BACKGROUND ART

A biosensor is a sensor which determines the content of a substrate in a sample by utilizing a molecular recognition ability of a biological material such as a microorganism, an enzyme, an antibody, a DNA or an RNA. Among various biosensors, a sensor utilizing an enzyme has been in practical use, and for example, glucose, lactic acid, cholesterol, amino acids, and the like in a substrate can be measured.

For example, the following Patent Document 1 discloses a biosensor, which is constituted by an electrically insulating substrate, an electrode system including a working electrode and a counter electrode formed on the electrically insulating substrate, and a reagent layer provided on the electrode system, and in which the reagent layer is composed mainly of a stacked body having a first layer and a second layer stacked sequentially, the first layer contains a hydrophilic polymer, an enzyme, and an electron acceptor, and the second layer contains a water-insoluble polymer and a water-soluble polymer.

Further, the following Patent Document 2 discloses a technique as a biosensor for measuring blood glucose levels, which mainly utilizes an electrochemical reaction, uses, for example, a reagent such as potassium ferricyanide as a mediator, causes glucose in blood and an enzyme such as glucose oxidase carried in the sensor to react with each other, and measures the obtained current value, thereby determining blood glucose levels.

On the other hand, as an index for the viscosity of blood, there has been known a hematocrit level. The hematocrit level is a ratio (%) of the volume of red blood cells in blood, and is generally from 40 to 50% in healthy adults. On the other hand, the hematocrit level decreases in anemia patients, and there is also a case that anemia patients are put into a state where the hematocrit level is lower than 15%. Such a variation in hematocrit level is known to adversely affect the determination of the concentration of a blood component, particularly glucose using a biosensor. However, any conventional techniques cannot cope with such a variation in hematocrit level and have a problem with measurement accuracy of the concentration of blood glucose.

### CITATION LIST

### Patent Documents

Patent Document 1: JP-A-6-213858

Patent Document 2: JP-T-2005-512027

### SUMMARY OF THE INVENTION

### Problems to be Solved by the Invention

In view of this, an object of the present invention is to provide a biosensor capable of measuring various blood components, in particular, the concentration of blood glucose with high accuracy even when a hematocrit level varies, and a method for producing the same.

### Means for Solving the Problems

As a result of intensive studies, the present inventors found that conventional problems as described above can be solved by providing a hydrophilic polymer layer on an electrode system including a working electrode and a counter electrode formed on an electrically insulating substrate, and providing a reagent layer containing an oxidoreductase and a redox mediator outside the hydrophilic polymer layer in a biosensor utilizing an electrochemical reaction, and thus, could complete the present invention.

That is to say, the present invention is as follows.

1. A biosensor, which oxidizes a blood component in a sample with an oxidoreductase, detects an oxidation current generated by the reaction product with an electrode, and measures the blood component, wherein the biosensor comprises an electrically insulating substrate, an electrode system including a working electrode and a counter electrode formed on the electrically insulating substrate, and a reagent layer containing an oxidoreductase and a redox mediator, the electrode system is formed from gold, a hydrophilic polymer layer is provided on the electrode system, and the hydrophilic polymer layer and the reagent layer containing an oxidoreductase and a redox mediator are disposed spaced apart from each other.
2. The biosensor described in 1 above, wherein the hydrophilic polymer layer is formed from a photocrosslinkable polymer.
3. The biosensor described in 2 above, wherein the photocrosslinkable polymer is a polymer containing polyvinyl alcohol as a backbone.
4. The biosensor described in any one of 1 to 3 above, wherein the reagent layer is provided above the hydrophilic polymer layer.
5. The biosensor described in any one of 1 to 4 above, wherein the biosensor is formed by providing an electrode system including a working electrode and a counter electrode, and a hydrophilic polymer layer in this order on an electrically insulating substrate, aside from this, providing a reagent layer containing an oxidoreductase and a redox mediator on a cover film, and integrally bonding the electrically insulating substrate, the electrode system, and the cover film to one another such that the hydrophilic polymer layer and the reagent layer face each other.
6. The biosensor described in any one of 1 to 5 above, wherein the blood component is glucose.
7. A method for producing the biosensor described in any one of 1 to 6 above, comprising: a first step of providing an electrode system including a working electrode and a counter electrode, and a hydrophilic polymer layer in this order on an electrically insulating substrate; a second step of providing a reagent layer containing an oxidoreductase and a redox mediator on a cover film; and a third step of integrally bonding the electrically insulating substrate, the electrode system, and the cover film to one another such that the hydrophilic polymer layer and the reagent layer face each other.

### Effect of the Invention

According to the present invention, a biosensor which measures a blood component in a sample by utilizing an electrochemical reaction is characterized in that the biosensor includes an electrode system including a working electrode and a counter electrode formed from gold on an electrically insulating substrate, and a reagent layer containing an oxidoreductase and a redox mediator, and the reagent layer is provided outside a hydrophilic polymer layer so that the oxidoreductase and the redox mediator are transferred to the hydrophilic polymer layer provided on the electrode system after coming into contact with the sample.

In this manner, since gold capable of rapidly detecting an electrochemical reaction is used as an electrode and also an oxidoreductase and a redox mediator are disposed outside a hydrophilic polymer layer, a sample containing a blood component is mixed outside the hydrophilic polymer layer along with a part or the whole of the oxidoreductase and the redox mediator and thereafter reaches the hydrophilic polymer layer, and the hydrophilic polymer layer functions like molecular sieve chromatography, and thus, the blood component such as glucose can be measured before biopolymer components such as red blood cells and an oxidoreductase reach the electrode. Accordingly, a biosensor capable of measuring various blood components with high accuracy even when a hematocrit level in blood varies, and a method for producing the same can be provided.

### BRIEF DESCRIPTION OF THE DRAWINGS

FIG. 1 is an exploded perspective view showing one example of a biosensor of the present invention.

FIG. 2 is a cross-sectional view taken along the line B-B of FIG. 1 showing one example of the biosensor of the present invention.

FIG. 3 is a plan view for illustrating an electrode to be used in the present invention.

FIGS. 4(a) to 4(d) are views showing a step of producing an electrode by a method using a printing mask formed by screen printing.

FIGS. 5(a) to 5(g) are views showing a step of producing an electrode by a method using a mask formed by photolithography.

FIGS. 6(a) to 6(c) are views showing results of Example 1.

FIGS. 7(a) to 7(d) are views showing results of Example 2.

FIGS. 8(a) to 8(d) are views showing results of Example 2.

FIGS. 9(a) to 9(d) are views showing results of Example 2.

FIGS. 10(a) to 10(c) are views showing results of Example 3.

FIGS. 11(a) to 11(c) are views showing results of Example 3.

FIGS. 12(a) to 12(c) are views showing results of Example 3.

FIG. 13 is a view showing results of Example 4.

FIGS. 14(a) to 14(c) are views showing results of Example 4.

FIGS. 15(a) to 15(e) are views showing a step of producing an interdigitated array electrode by a method using a metal mask.

FIGS. 16(a) to 16(d) are views showing a step of producing an interdigitated array electrode by a lift-off method.

### EMBODIMENTS FOR CARRYING OUT THE INVENTION

Hereinafter, the present invention will be described in more detail.

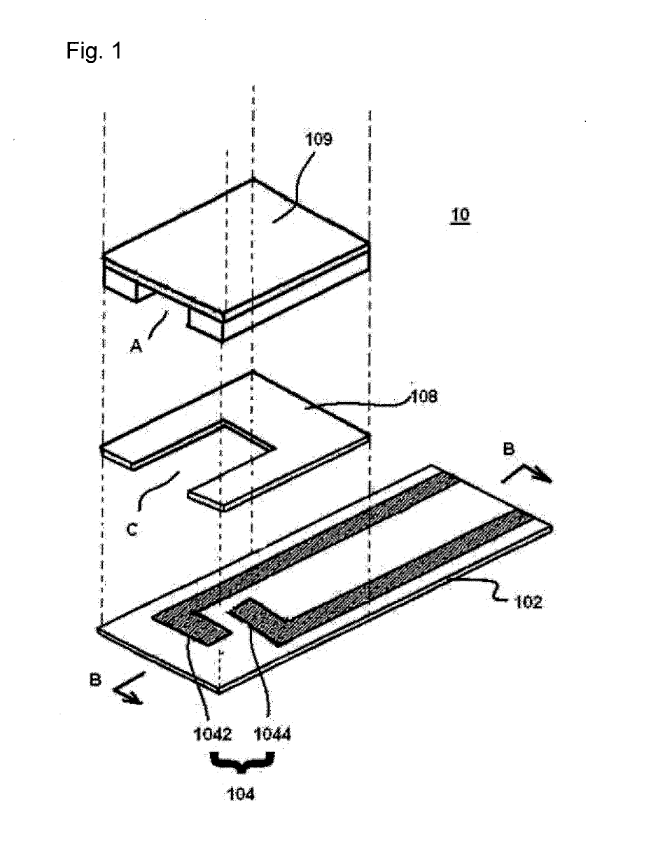

FIG. 1 is an exploded perspective view showing one example of a biosensor of the present invention (provided that a hydrophilic polymer layer on an electrode system and a reagent layer are omitted). In FIG. 1, a biosensor 10 oxidizes a blood component with an oxidoreductase, detects an oxidation current generated by the reaction with an electrode, and measures the blood component, and specifically, on an electrically insulating substrate 102, an electrode system 104 composed of a working electrode 1042 and a counter electrode 1044 is formed.

Further, in the biosensor 10, a spacer 108 and a cover film 109 are provided on the electrically insulating substrate 102, and these members are integrally provided. In addition, the spacer 108 is provided with a notch to form a cavity C.

When a blood component is measured, a blood sample in an amount of less than 1 μL, for example, 0.1 to 0.25 μL is introduced from a suction port A into the cavity C through a capillary phenomenon, and guided to a position where the electrode system 104 and a reagent layer (described below) are placed. Then, a current value generated by the reaction between blood and a reagent in the reagent layer on the electrode system 104 is read by an external measurement device through leads 112 and 114 (not shown).

In the present invention, the electrode system 104 is formed from gold, and also a hydrophilic polymer layer formed on the electrode and a reagent layer containing an oxidoreductase and a redox mediator are provided, and further, the reagent layer is provided outside (spaced apart from) the hydrophilic polymer layer so that the oxidoreductase and the redox mediator are transferred to the hydrophilic polymer layer after coming into contact with the sample.

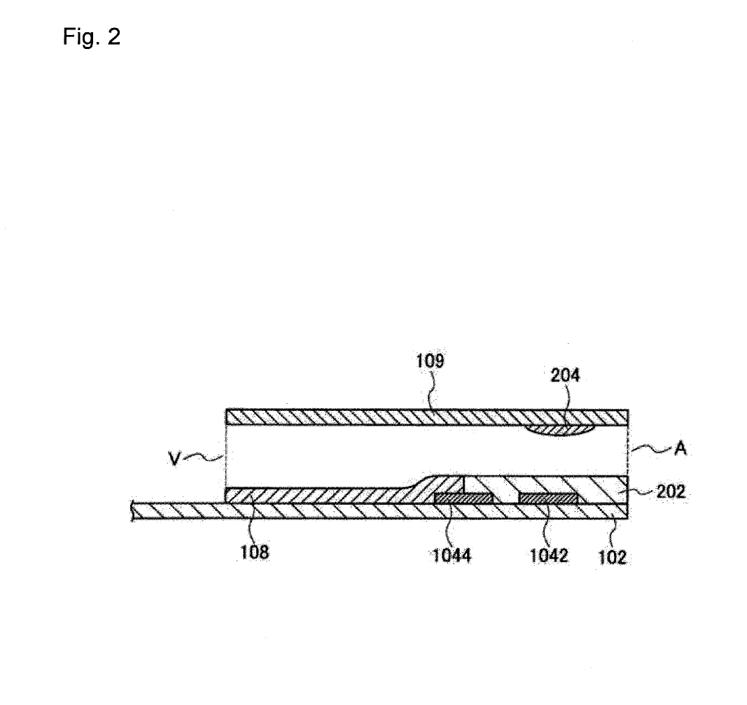

FIG. 2 is a cross-sectional view taken along the line B-B of FIG. 1 showing one example of the biosensor of the present invention.

As described above, the biosensor 10 of the present invention includes the electrically insulating substrate 102, and the electrode system 104 including the working electrode 1042 and the counter electrode 1044 formed thereon, and is provided with the hydrophilic polymer layer 202 on the electrode system 104. Further, on the hydrophilic polymer layer 202, the reagent layer 204 containing an oxidoreductase and a redox mediator is provided, and the oxidoreductase and the redox mediator in the reagent layer 204 are prevented from being transferred to the hydrophilic polymer layer 202 before coming into contact with a sample such as blood. Incidentally, a reference sign V denotes an air hole.

As a polymer for forming the hydrophilic polymer layer 202, from the viewpoint of the effect of the present invention and also from the viewpoint of ease of production, it is preferably formed from a photocrosslinkable polymer, and more preferably formed from particularly the following photosensitive resin composition.

That is, the photosensitive resin composition to be used in the above configuration is a composition containing a water-soluble polymer as a main component and also having a photosensitive group, but may be a composition containing a water-soluble polymer having a photosensitive group, and also may be a composition containing a water-soluble photocrosslinking agent, that is, a compound having a photosensitive group and a water-soluble polymer having no photosensitive group. Further, it may be a composition containing a water-soluble polymer having a photosensitive group, a water-soluble polymer having no photosensitive group, and a water-soluble photocrosslinking agent.

Incidentally, the content of the water-soluble polymer is preferably 70 wt % or more, and particularly preferably 85 wt % or more in the solid content in the photosensitive resin composition.

The photosensitive group of the photosensitive resin composition for forming the hydrophilic polymer layer 202 is not particularly limited and may be a group known as a photosensitive group, but is particularly preferably a photosensitive group having an azido group.

The photosensitive group having an azido group particularly preferably has a structure represented by either of the following formulae (1) and (2).

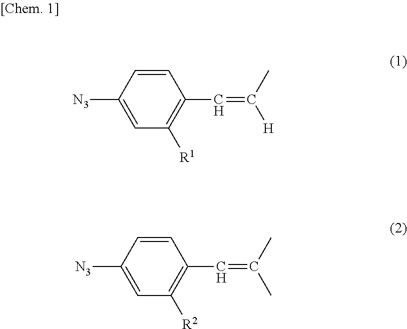

Incidentally, the formula (1) represents a monovalent group, and the formula (2) represents a divalent group, and in the formulae, R¹ and R² each represent a hydrogen atom, a sulfonic acid group, or a sulfonate group. The sulfonate group is represented by —SO₃M, and examples of M include alkali metals such as sodium and potassium. Further, the photosensitive group may be directly bonded to the water-soluble photocrosslinking agent or the water-soluble polymer or may be bonded thereto through a spacer such as alkylene or an amide bond.

As the water-soluble polymer, a water-soluble polymer known as a component of the photosensitive resin composition can be used, and examples thereof include saponified polyvinyl acetate (polyvinyl alcohol), polyvinylpyrrolidone, a poly(meth)acrylamide-diacetone(meth)acrylamide copolymer, poly(N-vinylformamide), and poly(N-vinylacetamide). Among these, saponified polyvinyl acetate can be preferably used. The polymerization degree and the saponification degree of the saponified polyvinyl acetate are not particularly limited, however, saponified polyvinyl acetate having an average polymerization degree of 200 to 5000 and a saponification degree of 60 to 100% can be preferably used. If the average polymerization degree is less than 200, it is difficult to obtain sufficient sensitivity, while if the average polymerization degree is more than 5000, the viscosity of the photosensitive resin composition is increased so that a problem that the application property is deteriorated is liable to occur, and moreover, if the concentration thereof is decreased for lowering the viscosity, it becomes difficult to obtain a desired coating film thickness. Further, if the saponification degree is less than 60%, it is difficult to obtain sufficient water solubility and water developability.

In order to obtain the water-soluble polymer having a photosensitive group, for example, a compound having a photosensitive group (a photosensitive group unit) may be reacted with a water-soluble polymer. Examples of the compound having a photosensitive group for introducing a photosensitive group into the water-soluble polymer include photosensitive group units described in JP-A-2003-292477 such as 3-(4-azidophenyl)-N-(4,4′-dimethoxybutyl)-2-phenylcarbonylamino-propa-2-eneamide), 2-(3-(4-azidophenyl)prop-2-enoylamino)-N-(4,4-dimethoxybutyl)-3-(3-pyridyl)prop-2-eneamide), and 3-(4-azidophenyl)-N-(4,4′-dimethoxybutyl)-2-[(3-pyridyl)carbonylamino]-propa-2-eneamide, and photosensitive group units described in Japanese Patent No. 3163036 such as 3-(2-dimethoxybutyl)-(4-azidobenzylidene-2-sodium sulfonate)rhodanine and 3-(2-dimethoxyethyl)-(4-azidobenzylidene-2-sodium sulfonate)rhodanine.

The water-soluble photocrosslinking agent is not particularly limited as long as it has a photosensitive group, however, as described above, it preferably has an azido group as the photosensitive group. Examples thereof include 4,4′-diazidostilbene-2,2′-disulfonic acid, 4,4′-diazidobenzalacetophenone-2-sulfonic acid, 4,4′-diazidostilbene-α-carboxylic acid, and alkali metal salts thereof, ammonium salts thereof, and organic amine salts thereof.

Further, the photosensitive resin composition is preferably brought to a solution state. A solvent for the photosensitive resin composition is not particularly limited as long as it can dissolve the components contained in the composition, however, water or a mixed solution of water and an organic solvent miscible with water can be used. Non-limiting examples of the organic solvent miscible with water include ketones such as acetone, lower alcohols such as methanol, acetonitrile, and tetrahydrofuran. Incidentally, the solid content concentration is preferably 10 wt % or less.

Further, it is also possible to mix an additive in the photosensitive resin composition as long as the photocurability thereof is not deteriorated.

The thickness of the applied photosensitive resin composition is not particularly limited as long as application can be performed, however, a preferred film thickness is from 50 to 300 If the film thickness is less than 50 μm, the suppression of the effect of hematocrit may sometimes be insufficient, while if it exceeds 300 μm, a signal intensity may sometimes be lowered.

The applied photosensitive resin composition may be subjected to a heating treatment as needed. The heating treatment is optional and does not require any particular conditions, however, the treatment is generally performed at 30 to 150° C. for about 1 minute to 10 hours, preferably at 35 to 120° C. for about 3 minutes to 1 hour.

A light source when performing light exposure is not particularly limited as long as it is a light source capable of exposing the photosensitive group to be used to light. For example, as the light source, an X-ray, an electron beam, an excimer laser (an F₂, ArF, or KrF laser, or the like), or a high-pressure mercury vapor lamp can be used. Among these light sources, a wavelength with high photosensitization efficiency can be appropriately selected. The light exposure energy can be appropriately set according to the structure of the photosensitive group and the energy of the light source to be used. The light exposure energy is generally from 0.1 mJ/cm² to 10 J/cm², preferably from 1 mJ/cm² to 1 J/cm².

After exposure to light, washing with water may be performed after heating as needed. The heating treatment is optional and does not require any particular conditions, however, the treatment is generally performed at 30 to 150° C. for about 1 minute to 10 hours, preferably at 35 to 120° C. for about 3 minutes to 1 hour.

The reagent layer 204 contains an oxidoreductase and a redox mediator. The oxidoreductase and the redox mediator may be appropriately selected according to the type of the blood component to be measured, however, examples of the oxidoreductase include glucose oxidase, lactate oxidase, cholesterol oxidase, cholesterol esterase, uricase, ascorbate oxidase, bilirubin oxidase, glucose dehydrogenase, lactate dehydrogenase, and lactate dehydrogenase. Examples of the redox mediator include potassium ferricyanide, p-benzoquinone or a derivative thereof, phenazine methosulfate, methylene blue, and ferrocene or a derivative thereof.

The biosensor of the present invention is particularly preferably used for measuring the concentration of glucose in blood.

As a method for providing the reagent layer 204 such that the oxidoreductase and the redox mediator are prevented from being transferred to the hydrophilic polymer layer 202 before coming into contact with a sample such as blood, for example, the following method is used.

First, on the electrically insulating substrate 102, the electrode system 104 including the working electrode 1042 and the counter electrode 1044 is provided. A method for forming the electrode system 104 can be appropriately selected from known methods. Further, on the electrode system 104, the hydrophilic polymer layer 202 is formed as described above. Incidentally, the hydrophilic polymer layer 202 is preferably dried after formation.

Aside from this, the reagent layer 204 containing an oxidoreductase and a redox mediator is provided on the cover film 109 by a known coating or printing method. Incidentally, the reagent layer 204 is preferably dried after formation.

Subsequently, the insulating substrate 102, the electrode system 104, and the cover film 109 are integrally bonded to one another such that the electrode system 104 and the reagent layer 204 face each other.

By producing the biosensor 10 through such steps, the oxidoreductase and the redox mediator are disposed outside the hydrophilic polymer layer 202, and therefore, a sample containing a blood component is mixed outside the hydrophilic polymer layer along with a part or the whole of the oxidoreductase and the redox mediator and thereafter reaches the hydrophilic polymer layer, and the hydrophilic polymer layer functions like molecular sieve chromatography, and thus, the blood component such as glucose can be measured before biopolymer components such as red blood cells and an oxidoreductase reach the electrode. Accordingly, various blood components can be measured with high accuracy even when a hematocrit level in blood varies.

Further, the electrode system 104 of the present invention is constituted by one working electrode 1042 and one counter electrode 1044, but may be constituted by an electrode composed of multiple working electrodes and multiple counter electrodes.

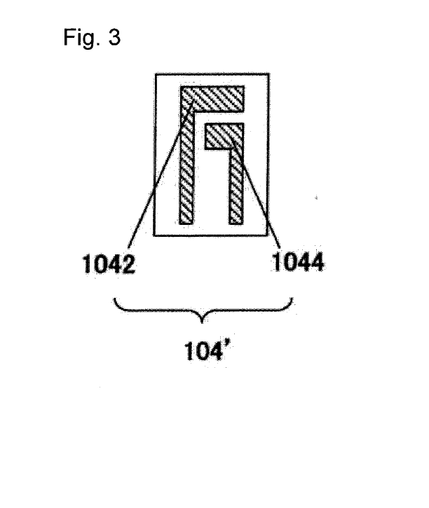

FIG. 3 is a plan view for illustrating the electrode to be used in the present invention. In FIG. 3, an electrode 104′ has a configuration in which each of the working electrode 1042 and the counter electrode 1044 is formed in the shape of a flat plate, and the working electrode 1042 and the counter electrode 1044 are disposed adjacent to each other.

The electrode 104′ to be used in the present invention can be formed by, for example, the following method.

(1) Method Using Printing Mask Formed by Screen Printing

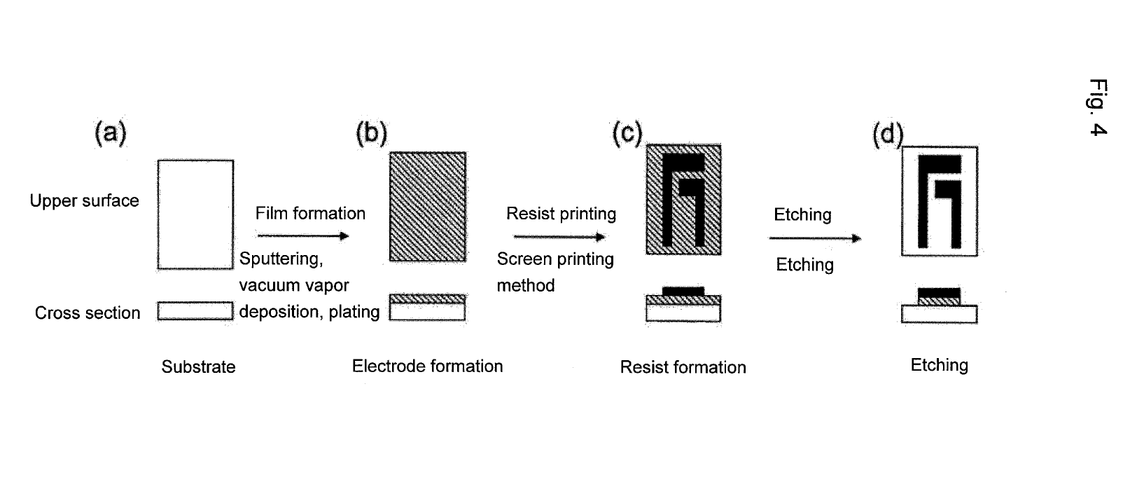

FIG. 4 is a view showing a step of producing the electrode 104′ by a method using a printing mask formed by screen printing.

First, an insulating substrate is prepared [FIG. 4(a)], and a noble metal film is formed on the insulating substrate by a means such as sputtering, vacuum vapor deposition, or plating of a noble metal constituting the electrode [FIG. 4(b)].

Subsequently, a resist is printed in the form of a flat plate on the electrode film by adopting a screen printing method [FIG. 4(c)], and etching is performed [FIG. 4(d)].

Finally, the resist is removed by a stripping solution or the like, whereby the electrode is completed [FIG. 4(e)].

(2) Method Using Mask Formed by Photolithography

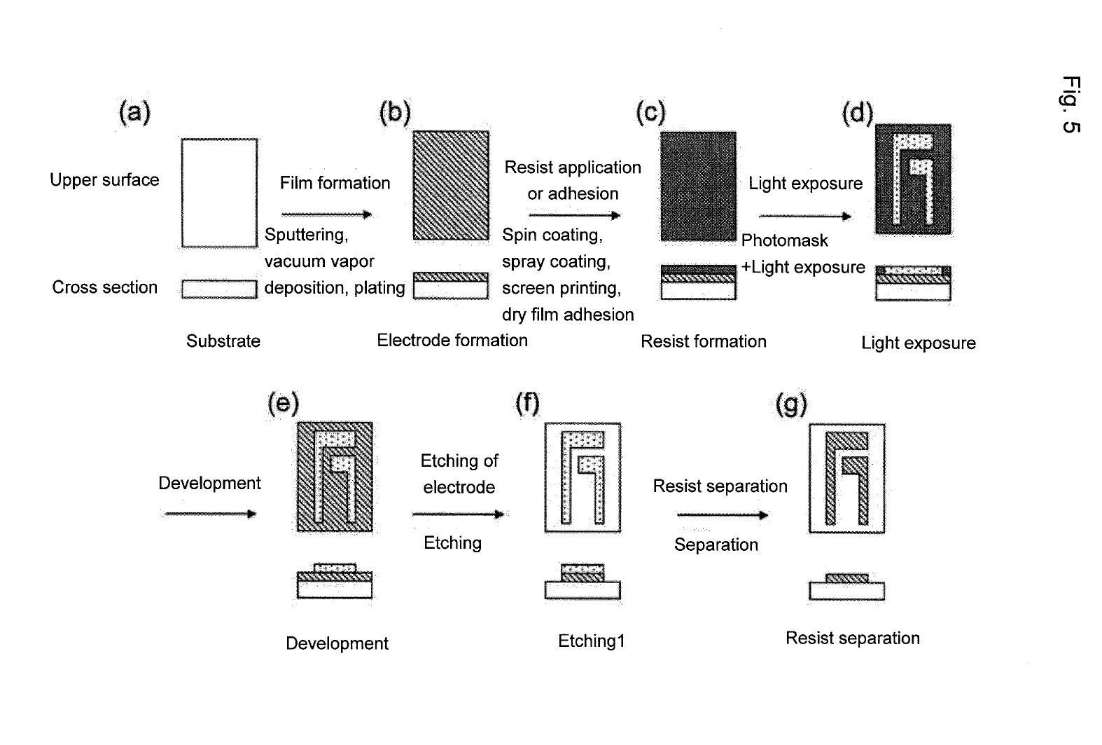

FIG. 5 is a view showing a step of producing an interdigitated array electrode 104′ by a method using a mask formed by photolithography

First, an electrically insulating substrate is prepared [FIG. 5(a)], and a noble metal film is formed on the electrically insulating substrate by a means such as sputtering, vacuum vapor deposition, or plating of a noble metal constituting the electrode [FIG. 5(b)].

Subsequently, a resist is applied or adhered on the noble metal film by adopting a means such as spin coating, spray coating, screen printing, or dry film adhesion [FIG. 5(c)], and light exposure is performed through a photomask [FIG. 5(d)].

Subsequently, the resist and the noble metal film in a portion other than a portion where the electrode is formed are etched [FIGS. 5(e) and 5(f)].

Finally, the resist in the portion where the electrode is formed is removed by a stripping solution or the like, whereby the electrode is completed [FIG. 5(g)].

(3) Method Using Metal Mask

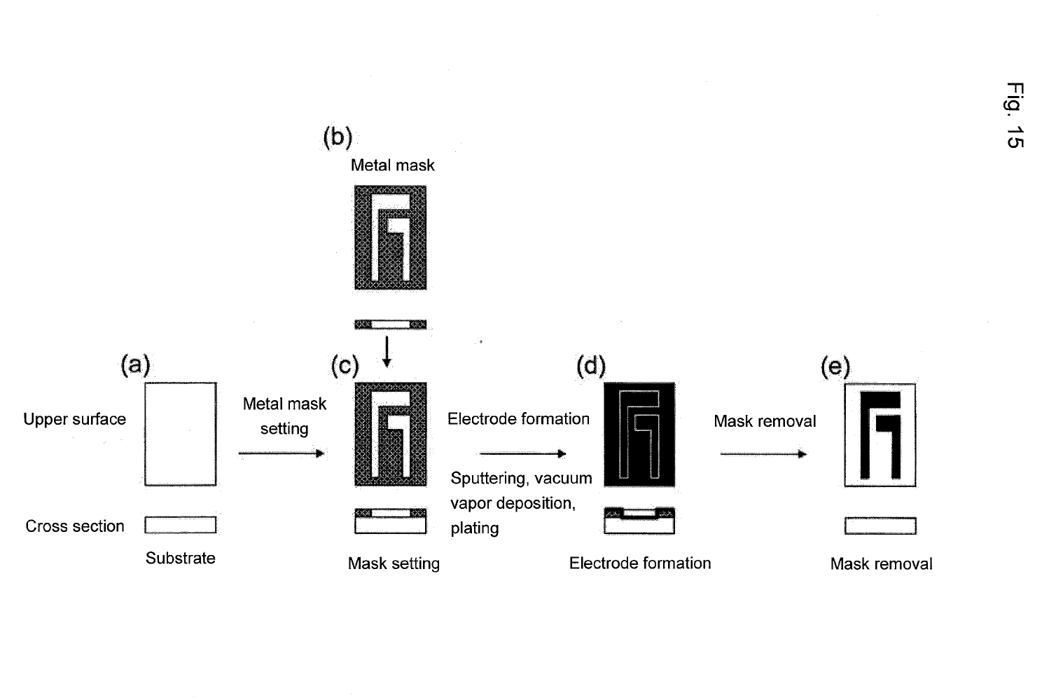

FIG. 15 is a view showing a step of producing an interdigitated array electrode 104′ by a method using a metal mask.

First, an electrically insulating substrate is prepared [FIG. 15(a)], and a template from which a pattern of the electrode to be produced has been removed (called “metal mask”) [FIG. 15(b)] is superimposed on the substrate [FIG. 15(c)], and then, the electrode is formed by a treatment with a means such as sputtering, vacuum vapor deposition, or plating of a noble metal constituting the electrode [FIG. 15(d)], whereby a noble metal film is formed on the electrically insulating substrate.

Subsequently, the metal mask is removed, whereby the electrode is completed [FIG. 15(d)].

(4) Lift-Off Method

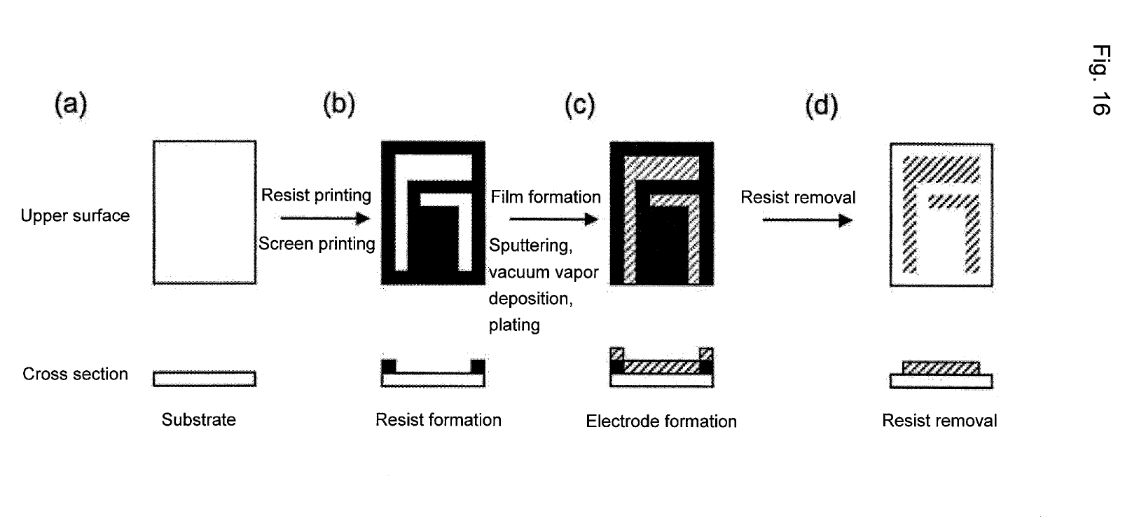

FIG. 16 is a view showing a step of producing an interdigitated array electrode 104′ by a lift-off method.

First, an insulating substrate is prepared [FIG. 16(a)], and a resist is printed in the form of a flat plate in a portion where the electrode is not formed by adopting a screen printing method [FIG. 16(b)], followed by drying.

Subsequently, on the substrate having the resist printed thereon, a noble metal film is formed by a means such as sputtering, vacuum vapor deposition, or plating of a noble metal constituting the electrode [FIG. 16(c)].

Finally, the resist and the noble metal film formed on the resist are removed by removing the resist with a stripping solution or the like, whereby the electrode is completed [FIG. 16(d)].

In the case of an electrode system including multiple working electrodes and multiple counter electrodes, from the viewpoint that a desired shape can be formed with high accuracy, it is preferred to adopt the method using a mask formed by photolithography in the above (2).

Examples of materials for forming the electrically insulating substrate 102, the spacer 108 and the cover film 109 include polyester, polyolefin, polyamide, polyesteramide, polyether, polyimide, polyamide-imide, polystyrene, polycarbonate, poly-p-phenylene sulfide, polyether ester, polyvinyl chloride and poly(meth)acrylic acid ester. In particular, a film composed of polyester, for example, polyethylene terephthalate, polyethylene-2,6-naphthalate, polybutylene terephthalate, or the like is preferred.

### EXAMPLES

Hereinafter, the present invention will be further described with reference to Examples and Comparative Examples, however, the present invention is not limited to the following examples.

### Example 1

### Examination of Concentration of AWP

[Method]

To a gold electrode 104 produced using a printing mask formed by screen printing,

(1) 1 mL of a 0.5% aqueous solution of a water-soluble photosensitive resin composition containing a compound having an azido-based photosensitive group pendant to polyvinyl alcohol and saponified polyvinyl acetate (Toyo Gosei Co., Ltd., product name: BIOSURFINE-AWP, hereinafter referred to as “AWP”),

(2) 1 mL of a 1% aqueous solution of AWP, or

(3) 1 mL of a 2% aqueous solution of AWP was applied and dried at 37° C. for 45 minutes, and then, exposure to UV (352 nm) at 60 mJ/cm³ (using CHIBI LIGHT model-1 for 30 sec) was performed, and the resulting electrode was placed in a box with silica gel and stored at room temperature. 100 mM potassium ferricyanide, glucose dehydrogenase (hereinafter referred to as “GDH”) at 2 unit/mL, 100 mM potassium phosphate buffer (hereinafter referred to as “PPB”) (pH 7.5), washed horse red blood cells with a different hematocrit level (hereinafter referred to as “Ht”) (Ht0, Ht20, or Ht40), and a 100 mg/dL glucose solution were mixed. The resulting mixture was added to the gold electrodes (1) to (3) or the gold electrode on which no components were placed, and after a potential of 0 mV was applied to a closed circuit for 5 seconds, a potential of +200 mV was applied to the closed circuit at each sampling time, and a current value was measured.

### [Results]

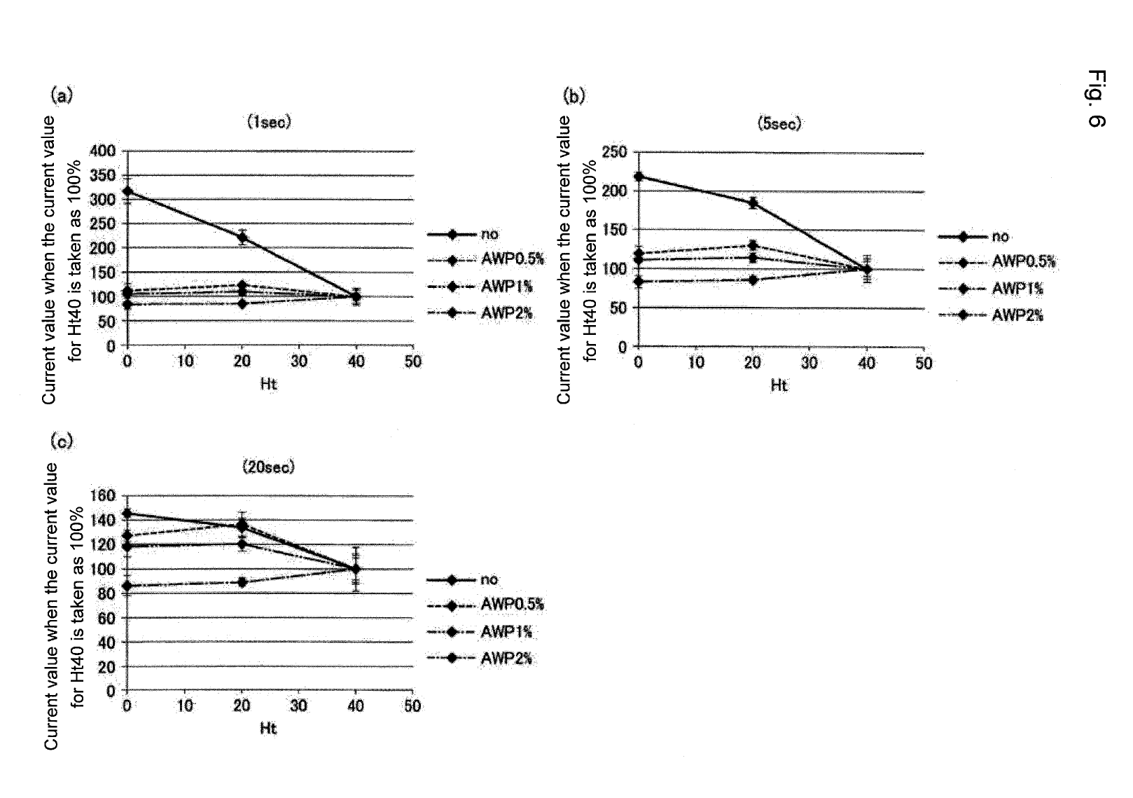

FIGS. 6(a) to 6(c) show views obtained by plotting the current values at sampling times of 1, 5, and 20 seconds for the respective hematocrit levels when the current value for Ht40 was taken as 100%. In the case of applying AWP, the current values were drastically decreased (the values at 1 sec were decreased to around 1/10). It was found that AWP is considerably effective in the effect of hematocrit, and the effect of hematocrit can be considerably excluded by AWP. With respect to the concentration of AWP, there is little difference in the range from 0.5% to 2%, however, in consideration that a variation is somewhat large in the case of 0.5%, and also from the viewpoint of ease of application, it was found that the concentration of AWP is preferably 1%.

### Example 2

### Method

To a gold electrode 104 produced using a printing mask formed by screen printing, 1 mL of a 1% aqueous solution of AWP was applied and dried at 37° C. for 45 minutes, and then, exposure to UV (352 nm) at 60 mJ/cm³ (using CHIBI LIGHT model-1 for 30 sec) was performed, and the resulting electrode was placed in a box with silica gel and stored at room temperature. To this electrode, 100 mM potassium ferricyanide, GDH at 1 unit/mL, 100 mM PPB (pH 7.5), and washed horse red blood cells Ht0, 20, 40, or 55 supplemented with glucose at 20, 100, 400, or 800 mg/dL were added. After a potential of 0 mV was applied to a closed circuit for 5 seconds, a potential of +200 mV was applied to the closed circuit at each sampling time, and a current value was measured.

### [Results]

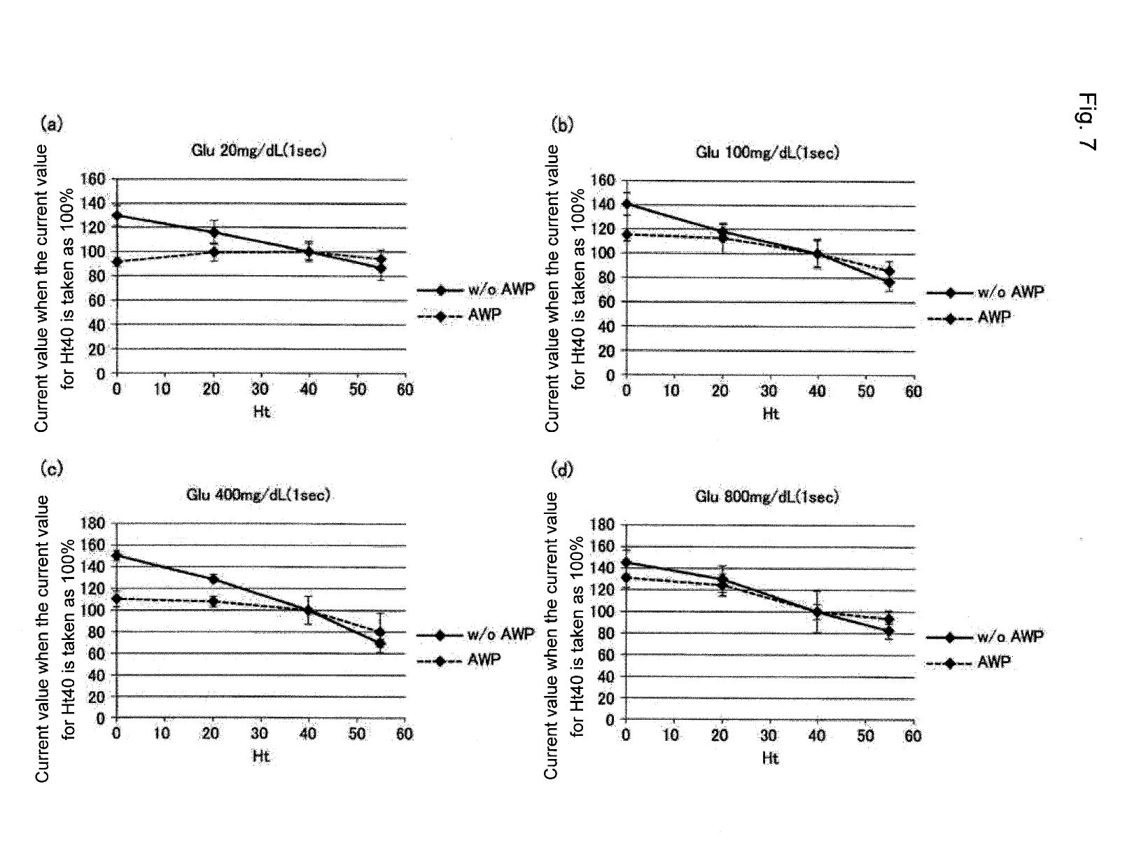

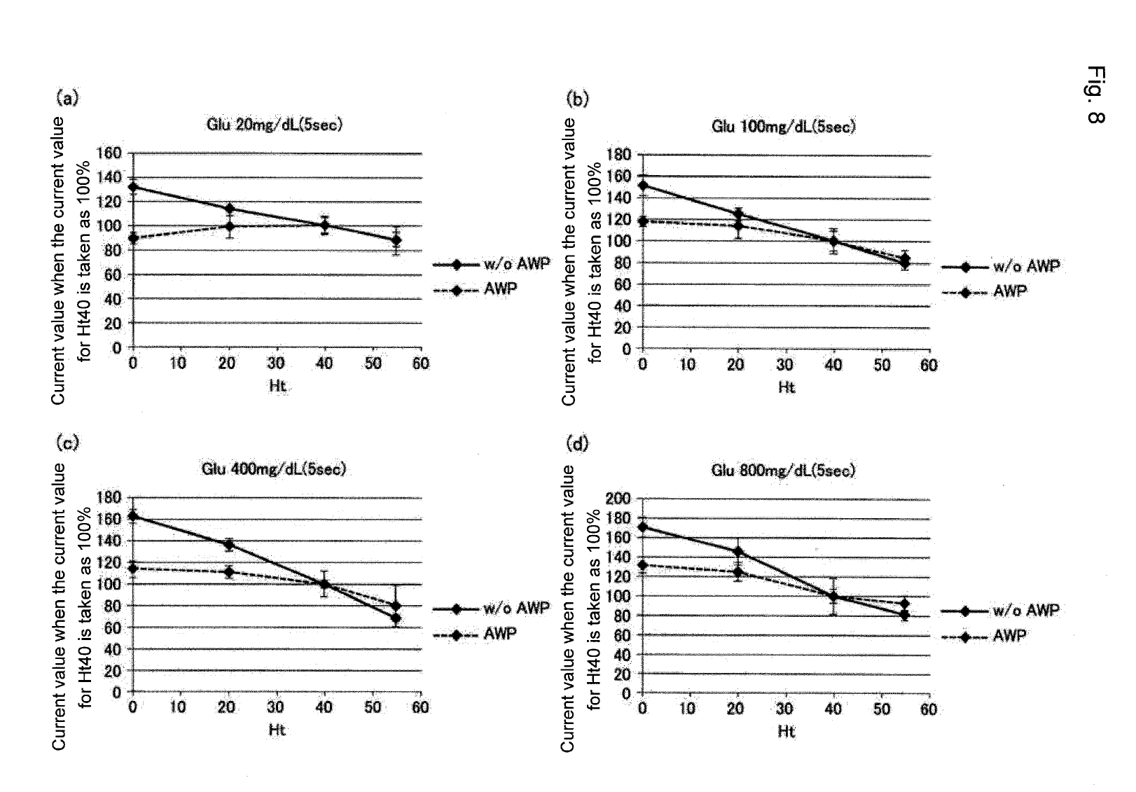

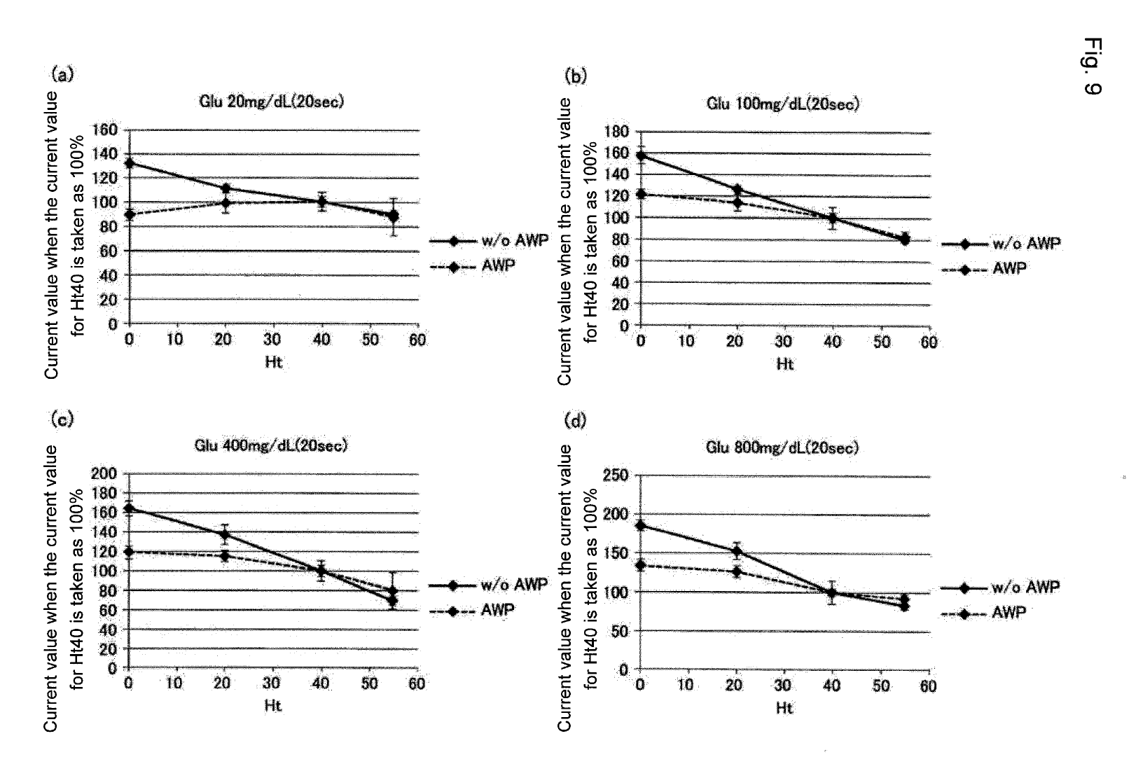

FIGS. 7(a) to 7(d), FIGS. 8(a) to 8(d), and FIGS. 9(a) to 9(d) show views obtained by plotting the current values at sampling times of 1, 5, and 20 seconds for the respective hematocrit levels when Ht40 was taken as 100%. AWP was effective at any glucose concentration, and the effect of hematocrit was decreased as compared with the case where AWP was not applied.

### Example 3

### Method

1. To a gold electrode 104 produced using a printing mask formed by screen printing, (4) 1 mL of a 0.5% aqueous solution of AWP supplemented with glucose dehydrogenase (hereinafter referred to as “GDH”) in an amount to give 2 unit/mL at the time of condensation to 0.8 mL, (5) 1 mL of a 1% aqueous solution of AWP supplemented with GDH in an amount to give 2 unit/mL at the time of condensation to 0.8 mL, or (6) 1 mL of a 2% aqueous solution of AWP supplemented with GDH in an amount to give 2 unit/mL at the time of condensation to 0.8 mL was applied and dried at 37° C. for 45 minutes, and then, exposure to UV (352 nm) at 60 mJ/cm³ (using CHIBI LIGHT model-1 for 30 sec) was performed, and the resulting electrode was placed in a box with silica gel and stored at room temperature. 100 mM potassium ferricyanide, GDH at 2 unit/mL, 100 mM PPB (pH 7.5), washed horse red blood cells Ht0, Ht20, or Ht40, and a 100 mg/dL glucose solution (with respect to GDH, for a sensor provided with the electrode on which GDH was already placed, a solution excluding GDH) were mixed. The resulting mixture was added to the gold electrodes (4) to (6) or the gold electrode on which no components were placed, and after a potential of 0 mV was applied to a closed circuit for 5 seconds, a potential of +200 mV was applied to the closed circuit for 30 seconds, and a current value was measured.

2. To a gold electrode 104 produced using a printing mask formed by screen printing, 1 mL of a 1% aqueous solution of AWP was applied and dried at 37° C. for 45 minutes, and then, exposure to UV (352 nm) at 60 mJ/cm³ (using CHIBI LIGHT model-1 for 30 sec) was performed. Thereafter, 1 mL of a solution prepared so that the concentrations of the respective components at the time of condensation to 0.8 mL were as follows: 200 mM potassium ferricyanide, GDH at 2 unit/mL, 100 mM PPB (pH 7.5), 0.3% lucentite SWN, and 50 mM sucrose, was applied on the electrode to which AWP was applied or the electrode to which AWP was not applied as a control and dried at 37° C. for 10 min and at 50° C. for 5 min, and the resulting electrode was placed in a box with silica gel and stored at room temperature. To this electrode, washed horse red blood cells Ht0, 20, 40, or 60 supplemented with glucose at 100 mg/dL was added, and after a potential of 0 mV was applied to a closed circuit for 5 seconds, a potential of +200 mV was applied to the closed circuit at each sampling time, and a current value was measured.

3. To a gold electrode 104 produced using a printing mask formed by screen printing, 1 mL of a 1% aqueous solution of AWP was applied and dried at 37° C. for 45 minutes, and then, exposure to UV (352 nm) at 60 mJ/cm³ (using CHIBI LIGHT model-1 for 30 sec) was performed. Thereafter, 1 mL of a solution prepared so that the concentrations of the respective components at the time of condensation to 0.8 mL were as follows: 200 mM potassium ferricyanide, GDH at 2 unit/mL, 100 mM PPB (pH 7.5), 0.3% lucentite SWN, and 50 mM sucrose, was applied on a capillary seal and dried at 37° C. for 10 mM and at 50° C. for 5 min. The thus obtained material was bonded to the gold electrode to which AWP was applied or the gold electrode to which AWP was not applied so that the surface of the capillary seal on which the reagent was applied faced the surface of the electrode, and the resulting electrode was placed in a box with silica gel and stored at room temperature. To this electrode, washed horse red blood cells Ht0, 20, 40, or 60 supplemented with glucose at 100 mg/dL was added, and after a potential of 0 mV was applied to a closed circuit for 5 seconds, a potential of +200 mV was applied to the closed circuit at each sampling time, and a current value was measured.

### [Results]

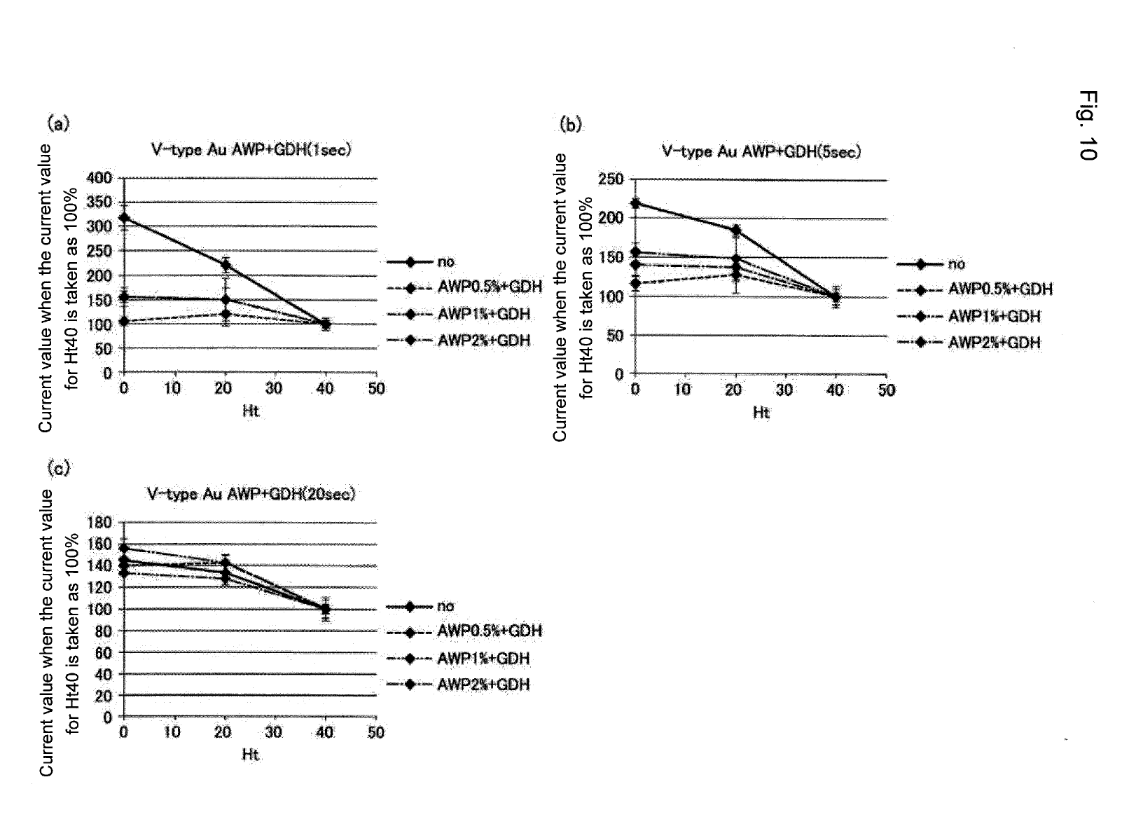

1. FIGS. 10(a) to 10(c) show the current values at sampling times of 1, 5, and 20 seconds for the respective hematocrit levels when the current value for Ht40 in the case where GDH was mixed in AWP and the resulting mixture was applied was taken as 100%. As compared with the results of Example 1, with respect to the effect of hematocrit throughout the entire test, little effect of hematocrit was observed in the case where only AWP was applied, however, the effect of hematocrit was observed in the case where GDH was mixed in AWP and the resulting mixture was applied. Therefore, since GDH were contained in considerably excessive amounts exceeding 1.6 unit/mL as the fixable amount for AWP, a void which red blood cells can access may be formed.

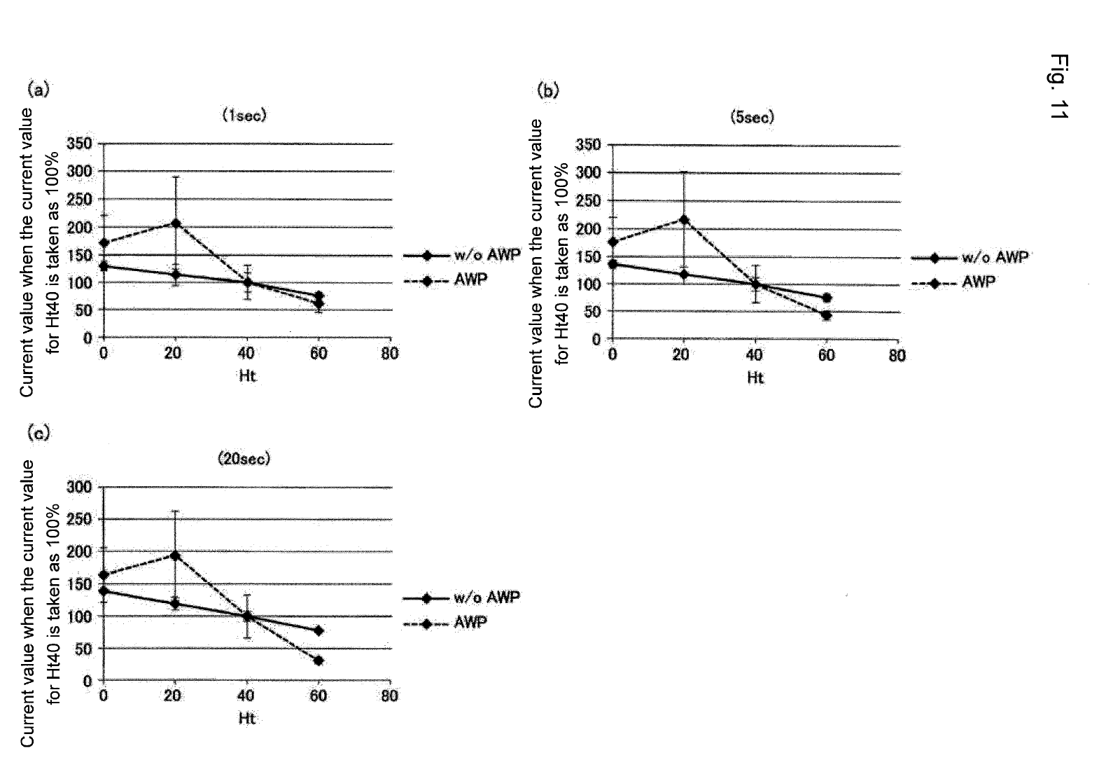

2. FIGS. 11(a) to 11(c) show views obtained by plotting the current values at sampling times of 1, 5, and 20 seconds for the respective hematocrit levels when the current value for Ht40 was taken as 100%. It seems that when the reagent is applied on the AWP film and dried, the condition of the film is deteriorated, and therefore, a considerably larger effect was observed as compared with the case where AWP was not applied.

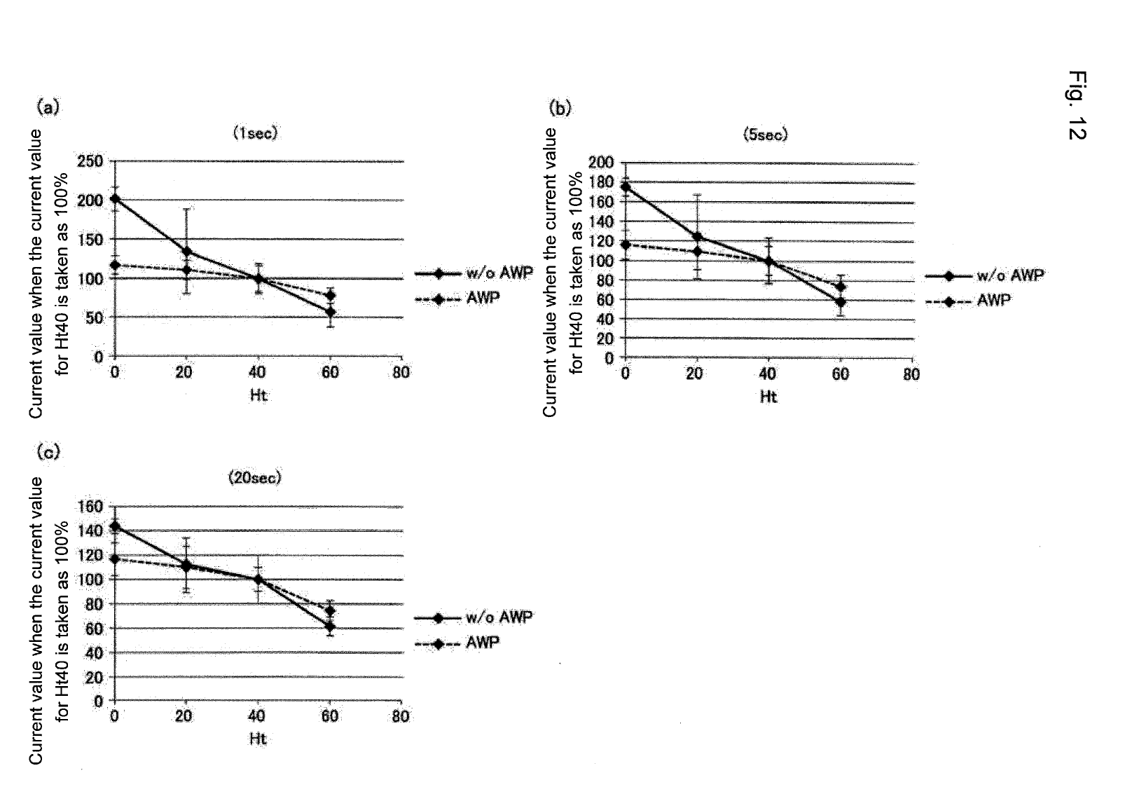

3. FIGS. 12(a) to 12(c) show views obtained by plotting the current values at sampling times of 1, 5, and 20 seconds for the respective hematocrit levels when the current value for Ht40 was taken as 100%. In the case where the reagent was applied on the AWP film in the above 2, the electrode was more susceptible to the effect of hematocrit, however, according to the method of applying the reagent to a capillary seal, the measurement can be performed. Thus, it was found that the method has an effect that the electrode is less susceptible to the effect of hematocrit.

### Example 4

### Method

To a gold electrode 104 produced using a printing mask formed by screen printing, 1 mL of a 1% aqueous solution of AWP was applied and dried at 37° C. for 45 minutes, and then, exposure to UV (352 nm) at 60 mJ/cm³ (using CHIBI LIGHT model-1 for 30 sec) was performed. Thereafter, 1 mL of a solution prepared so that the concentrations of the respective components at the time of condensation to 0.8 mL were as follows: 200 mM potassium ferricyanide, GDH at 2 unit/mL, 100 mM PPB (pH 7.5), 0.3% lucentite SWN, and 50 mM sucrose, was applied on a capillary seal and dried at 37° C. for 10 min and at 50° C. for 5 min. The thus obtained material was bonded to the gold electrode to which AWP was applied so that the surface of the capillary seal on which the reagent was applied faced the surface of the electrode, and the resulting electrode was placed in a box with silica gel and stored at room temperature. To this electrode, a glucose solution having a different concentration was added, and after a potential of 0 mV was applied to a closed circuit for 5 seconds, a potential of +200 mV was applied to the closed circuit at each sampling time, and a current value was measured.

### [Results]

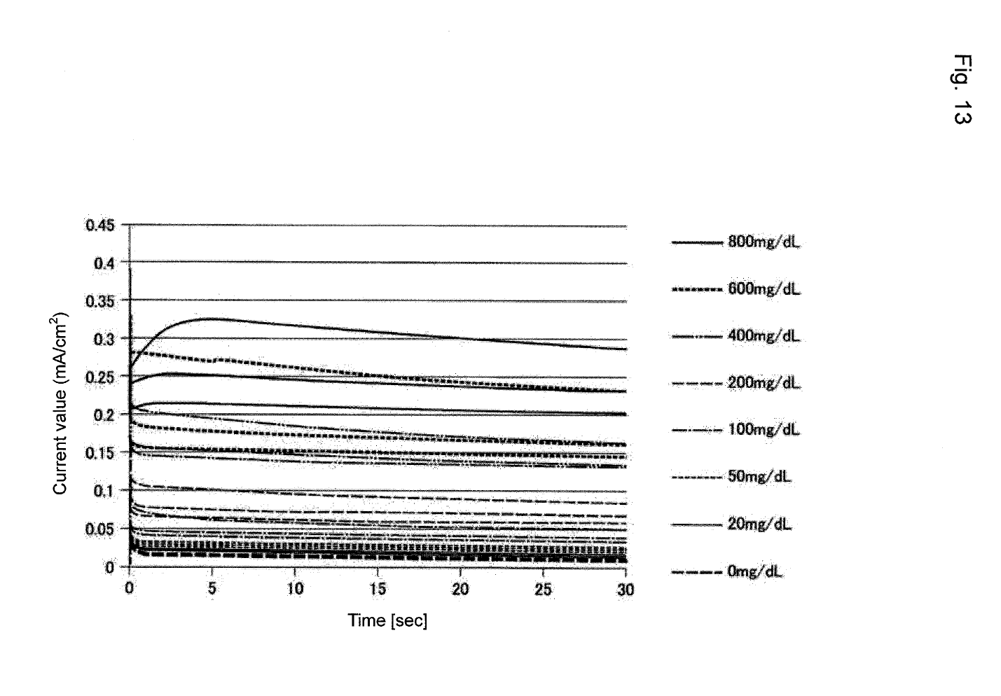

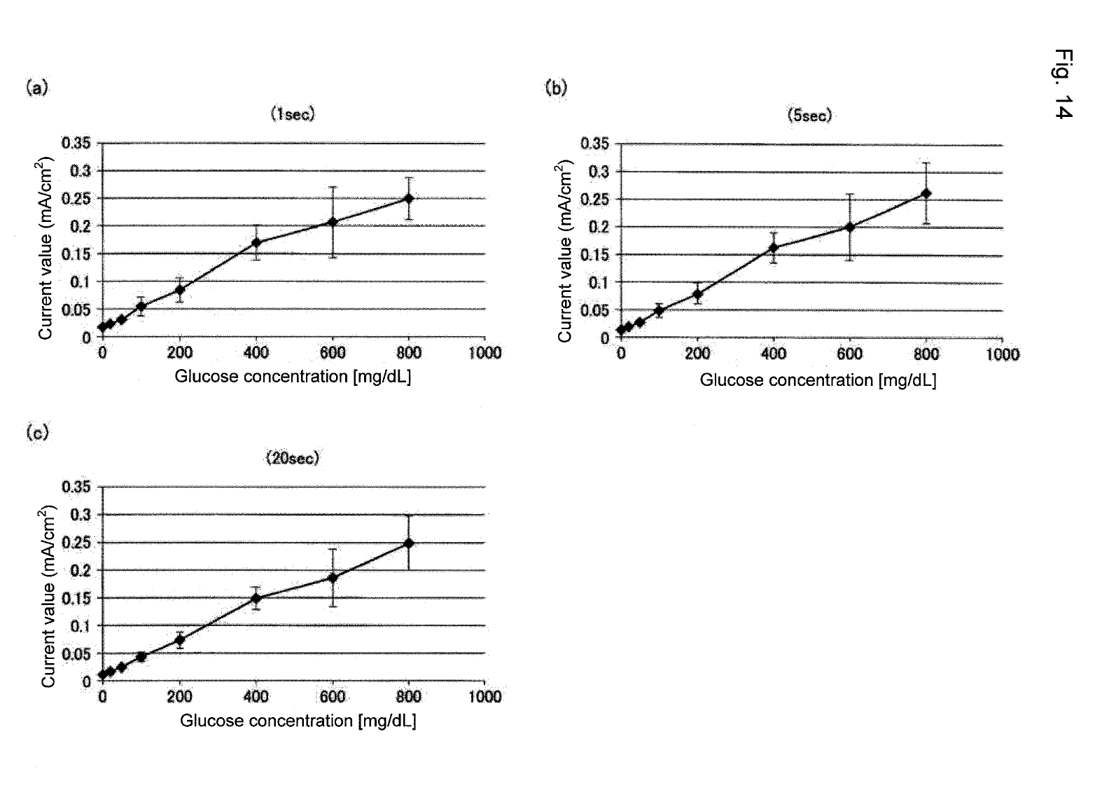

FIG. 13 shows the time course of the current value, and FIGS. 14(a) to 14(c) show the results of the current values at sampling times of 1, 5, and 20 seconds. A variation is slightly large at high glucose concentrations, however, linearity was obtained up to 800 mg/dL. By applying AWP on the electrode side, and by applying the reagent such as the enzyme and the mediator on the capillary side, the measurement could be performed.

While the present invention is herein described in detail with reference to specific embodiments, it will be apparent to those skilled in the art that various modifications and variations can be made without departing from the spirit and scope of the invention. The present application is based on Japanese Patent Application (Japanese Patent Application No. 2013-006560) filed on Jan. 17, 2013, the entire contents of which are incorporated herein by reference.

### DESCRIPTION OF REFERENCE NUMERALS AND SIGNS

10: biosensor
102: insulating substrate
104: electrode system
1042: working electrode
1044: counter electrode
108: spacer
109: cover film
202: hydrophilic polymer layer
204: reagent layer
A: suction port
C: cavity
V: air hole

1. A biosensor, which oxidizes a blood component in a sample with an oxidoreductase, detects an oxidation current generated by the reaction product with an electrode, and measures the blood component, wherein
the biosensor comprises an electrically insulating substrate, an electrode system including a working electrode and a counter electrode formed on the electrically insulating substrate, and a reagent layer containing an oxidoreductase and a redox mediator,
the electrode system is formed from gold,
a hydrophilic polymer layer is provided on the electrode system,
the hydrophilic polymer layer and the reagent layer containing an oxidoreductase and a redox mediator are disposed spaced apart from each other,
the hydrophilic polymer layer is formed from a photocrosslinkable polymer, and
the photocrosslinkable polymer is a polymer containing polyvinyl alcohol as a backbone.

2. The biosensor according to claim 1, wherein the reagent layer is provided above the hydrophilic polymer layer.

3. The biosensor according to claim 1, wherein the biosensor is formed by providing an electrode system including a working electrode and a counter electrode, and a hydrophilic polymer layer in this order on an electrically insulating substrate, aside from this, providing a reagent layer containing an oxidoreductase and a redox mediator on a cover film, and integrally bonding the electrically insulating substrate, the electrode system, and the cover film to one another such that the hydrophilic polymer layer and the reagent layer face each other.

4. The biosensor according to claim 1, wherein the blood component is glucose.

5. A method for producing the biosensor according to claim 1, comprising:
a first step of providing an electrode system including a working electrode and a counter electrode, and a hydrophilic polymer layer in this order on an electrically insulating substrate;
a second step of providing a reagent layer containing an oxidoreductase and a redox mediator on a cover film; and
a third step of integrally bonding the electrically insulating substrate, the electrode system, and the cover film to one another such that the hydrophilic polymer layer and the reagent layer face each other.

6. The biosensor according to claim 2, wherein the biosensor is formed by providing an electrode system including a working electrode and a counter electrode, and a hydrophilic polymer layer in this order on an electrically insulating substrate, aside from this, providing a reagent layer containing an oxidoreductase and a redox mediator on a cover film, and integrally bonding the electrically insulating substrate, the electrode system, and the cover film to one another such that the hydrophilic polymer layer and the reagent layer face each other.

7. The biosensor according to claim 2, wherein the blood component is glucose.

8. The biosensor according to claim 3, wherein the blood component is glucose.

9. A method for producing the biosensor according to claim 2, comprising:
a first step of providing an electrode system including a working electrode and a counter electrode, and a hydrophilic polymer layer in this order on an electrically insulating substrate;
a second step of providing a reagent layer containing an oxidoreductase and a redox mediator on a cover film; and
a third step of integrally bonding the electrically insulating substrate, the electrode system, and the cover film to one another such that the hydrophilic polymer layer and the reagent layer face each other.

10. A method for producing the biosensor according to claim 3, comprising:
a first step of providing an electrode system including a working electrode and a counter electrode, and a hydrophilic polymer layer in this order on an electrically insulating substrate;
a second step of providing a reagent layer containing an oxidoreductase and a redox mediator on a cover film; and
a third step of integrally bonding the electrically insulating substrate, the electrode system, and the cover film to one another such that the hydrophilic polymer layer and the reagent layer face each other.

11. A method for producing the biosensor according to claim 4, comprising:
a first step of providing an electrode system including a working electrode and a counter electrode, and a hydrophilic polymer layer in this order on an electrically insulating substrate;
a second step of providing a reagent layer containing an oxidoreductase and a redox mediator on a cover film; and
a third step of integrally bonding the electrically insulating substrate, the electrode system, and the cover film to one another such that the hydrophilic polymer layer and the reagent layer face each other.
